(19) United States
(12) Patent Application Publication
(10) Pub. No.: US 2004/0013937 A1
(43) Pub. Date: Jan. 22, 2004

(54) Corrosive vapor absorption and neutralization system

(76) Inventors: James Michael Mullins, Peoria, AZ (US); William E. Mehlhaff, Peoria, AZ (US)

Correspondence Address: STONEMAN LAW OFFICES, LTD, 3113 NORTH 3RD STREET, PHOENIX, AZ, 85012, US

(21) Appl. No.: 10/620,750

(22) Filed: Jul. 15, 2003

Related U.S. Application Data
(60) Provisional application No. 60/396,470, filed on Jul. 16, 2002.

(51) Int. Cl. H01M 2/12

(52) U.S. Cl. 429/82; 429/90

(57) ABSTRACT

A method and system for the prevention of corrosion of objects located close to a wet cell storage battery caused by evaporation, and subsequent condensation, of electrolyte from a wet cell storage battery. Convenient methods for installation and removal of the system are included. Additionally, convenient and safe storage methods are also provided.

### CROSS-REFERENCE TO RELATED APPLICATION

The present application is related to and claims priority from prior provisional application Serial No. 60/396,470, filed Jul. 16, 2002, entitled “BATTERY COVER SYSTEM”, the contents of which are incorporated herein by this reference and are not admitted to be prior art with respect to the present invention by the mention in this cross-reference section.

### BACKGROUND

This invention relates to providing a system for improved protection from corrosive vapor emitted by wet cell storage batteries. Typically, conventional wet cell storage batteries contain acid electrolytes, such as sulfuric acid. It is well known that these batteries emit corrosive vapor primarily during periods of use and periods of recharge. After escaping from a battery, the corrosive vapor has an unfortunate tendency to quickly condense on any object close to the battery. It is easy to observe the corrosive impact the vapor has on metallic objects, including battery terminals, cables, battery holders and any other metallic parts near the battery. Paint applied to parts near a battery will also suffer from the same corrosive effects of the vapor.

It is also known that wet cell storage batteries emit corrosive vapor during periods when the equipment in which they are used is not in operation. Although the amount of corrosive vapor produced may be less than the amount produced during periods of use and periods of recharge, damage to surrounding metallic parts and paint can still occur. And for batteries whose use is highly intermittent, with long storage periods, e.g. for typical boats, damage from such vapor is a major concern.

A number of solutions to the problem of corrosive vapor have been proposed, and many are effective for prevention of corrosion after the corrosive vapor has condensed on nearby parts. Examples of these solutions include the use of felt impregnated with an acid neutralizer, placed under the cable terminals, to neutralize the condensed vapor in the vicinity of the cable terminals. Other solutions suggest placing felt sheets impregnated with an acid neutralizer under the battery, again to neutralize the condensed corrosive vapor. One shortcoming of these solutions is the lack of protection they provide to parts near the battery, which may also be corroded by the condensed vapor.

As can be seen, some of the current methods in use are ineffective in preventing the escaping corrosive vapor from settling on nearby parts. Additionally, no solution to date uses a method for absorption and neutralization of the corrosive vapor, which would prevent condensation on nearby parts. Finally, none of the existing methods provides a convenient and safe method of installation and removal.

### OBJECTS AND FEATURES OF THE INVENTION

A primary object and feature of the present invention is to provide a system and method for resolving the problems identified above. It is a further primary object and feature of the present invention to provide such a system and method to absorb emitted corrosive vapor from wet cell storage batteries upon emission by the battery and prior to condensation. A further primary object and feature of the invention is to neutralize the corrosive vapor upon absorption. It is yet another primary object and feature of the present invention to provide a system and method of installation that is safe and convenient.

A further primary object and feature of the present invention is to provide such a system and method of safe and convenient storage of the product after use. Yet another primary objective of the present invention is to provide such a system that is efficient, inexpensive and convenient. Other objects and features of this invention will become apparent with reference to the following descriptions.

### SUMMARY OF THE INVENTION

In accordance with a preferred embodiment hereof, this invention provides a protection system for at least one object susceptible to damage in proximity to at least one wet cell storage battery, having at least one top substantially horizontal surface, emitting at least one corrosive vapor and at least one volatile gas during at least one period of inactivity, comprising, in combination: cover means for covering substantially entirely the top substantially horizontal surface of the at least one wet cell storage battery; wherein such cover means comprises: capture means for capturing the at least one corrosive vapor; and passage means for passing the at least one volatile gas through such cover means. Moreover, it provides such a protection system, wherein such capture means comprises neutralization means for substantially neutralizing the at least one corrosive vapor.

Additionally, it provides such a protection system, further comprising: installation means for assisting the installation of such at least one protection system by at least one hand of at least one user; and removal means for removing, from over the at least one wet cell storage battery, such protection system utilizing the at least one hand of the at least one user. Also, it provides such a protection system, comprising: protective means for protecting the at least one hand of the at least one user. In addition, it provides such a protection system, further comprising: instructive means for providing instructions to at least one user regarding usage of such protection system. And, it provides such a protection system, further comprising: package means for packaging such at least one protection system. Further, it provides such a protection system, wherein such package means comprises: re-useable closure means for re-usably closing such package means. Even further, it provides such a protection system, wherein such package means comprises: first indicator means for indicating which corresponding side of such package means is meant to correspond to which corresponding side of such cover means.

Moreover, it provides such a protection system, wherein such cover means further comprises: second indicator means for indicating which side of such cover means is meant to be placed touching the top substantially horizontal surface of the at least one wet cell storage battery. Additionally, it provides such a protection system, wherein: such cover means, such protective means, and such instructive means are placed inside such package means and together sold as at least one kit.

In accordance with another preferred embodiment hereof, this invention provides a protection system for at least one object susceptible to damage in proximity to at least one wet cell storage battery, having at least one top substantially horizontal surface, emitting at least one corrosive vapor and at least one volatile gas during at least one period of inactivity, comprising, in combination: at least one cover structured and arranged to cover substantially entirely the top substantially horizontal surface of the at least one wet cell storage battery; wherein such at least one cover comprises at least one capturer structured and arranged to capture the at least one corrosive vapor, and at least one passer structured and arranged to pass the at least one volatile gas through such at least one cover.

Additionally, it provides such a protection system, wherein such at least one capturer comprises: at least one neutralizer structured and arranged to substantially neutralize the at least one corrosive vapor. In addition, it provides such a protection system, further comprising: at least one installer structured and arranged to assist installation of such at least one protection system by at least one hand of at least one user; and at least one remover structured and arranged to remove, from over the at least one wet cell storage battery, such protection system utilizing the at least one hand of the at least one user. And, it provides such a protection system, comprising: at least one protector structured and arranged to protect the at least one hand of the at least one user. Further, it provides such a protection system, further comprising: at least one instruction structured and arranged to provide instruction regarding usage of such protection system.

Even further, it provides such a protection system, further comprising: at least one package structured and arranged to provide packaging of such at least one protection system. Moreover, it provides such a protection system, wherein such at least one package comprises: at least one re-useable closure structured and arranged to re-usably close such at least one package. Additionally, it provides such a protection system, wherein such at least one package comprises: at least one first indicator structured and arranged to indicate which corresponding side of such at least one package is meant to correspond to which corresponding side of such at least one cover. Also, it provides such a protection system, wherein such at least one cover further comprises: at least one second indicator structured and arranged to indicate which side of such at least one cover is meant to be placed touching the top substantially horizontal surface of the at least one wet cell storage battery. In addition, it provides such a protection system, wherein: such at least one cover, such at least one protector, and such at least one instruction, are placed inside such at least one package and together sold as at least one kit.

In accordance with another preferred embodiment hereof, this invention provides a method of minimizing escape of at least one harmful vapor from at least one wet cell storage battery comprising, in combination, the steps of: covering at least one wet cell storage battery with a harmful-vapor neutralizing material during a period of inactivity; wherein said covering step comprises using indicia on the material to determine which side of the material is placed touching the top substantially horizontal surface of such at least one wet cell storage battery, using such indicia on the material to determine the substantially clean side of the material, using at least one glove to grasp the substantially clean side of the material; removing the material from such at least one wet cell storage battery prior to at least one period of activity; wherein said removing step comprises using indicia on the material to determine the substantially clean side of the material, using at least one glove to grasp the material on the substantially clean side of the material, inserting the material into a closeable pouch to safely store the material; wherein said inserting step comprises providing indicia on the material to determine the substantially clean side of the material, inserting the material utilizing indicia on the material and indicia on the closeable pouch to arrange the respective sides with indicia together; and closing such closeable pouch.

In accordance with another preferred embodiment hereof, this invention provides a manufacturing system, which minimizes escape of at least one harmful vapor from at least one wet cell storage battery, utilizing felt rolls, an acid-absorbing solution, and a neutralizing solution, comprising, in combination, the steps of: cutting felt to at least one desired width; immersing the felt in the solutions; extracting excess solutions from the felt; drying the impregnated felt; and cutting the impregnated felt to at least one desired length. And, it provides such a system further comprising the step of imprinting at least one logo and indicia on the felt. Further, it provides such a system further comprising the step of assembling at least one wet cell storage battery kit.

Definitions

Period of inactivity—This term is sometimes used herein to refer to times when a wet cell storage battery is not providing electrical power to a device to which it is connected. Periods of inactivity may include times when the wet cell storage battery is being recharged by a charging system independent of the device to which it is connected.

### BRIEF DESCRIPTION OF THE DRAWINGS

FIG. 1 is a perspective view of the components of the system according to a preferred embodiment of the present invention. The preferred components include: 1) a polyethylene storage bag with a resealable closure; 2) a polyethylene glove; 3) instructions for usage and safe handling; and 4) the battery cover.

FIG. 2 is a perspective view, which shows the preferred components of the system in conjunction with a typical wet cell storage battery.

FIG. 3 is a perspective view of the preferred components of the system and a typical wet cell storage battery illustrating preferred placement of the battery cover on a typical wet cell storage battery.

FIG. 4 is a close-up perspective illustrating the preferred placement of the battery cover atop a typical wet cell storage battery.

FIG. 5 is a cross-sectional view of the preferred placement of the battery cover atop a wet cell storage battery. Depicted are the emissions of corrosive vapor and hydrogen gas from a typical wet cell storage battery and the preferably intended absorption by the battery cover of the corrosive vapor and its preferable permeability to hydrogen gas.

FIG. 6 is a perspective view of the preferred first step in the process of preferred usage of the battery cover. The preferred first step of the process is removal of the battery cover from the polyethylene storage bag.

FIG. 7 is a perspective view of the preferred method of grasping the battery cover in the second step in the process of preferred usage of the battery cover.

FIG. 8 is a perspective view of the preferred second step in the process of preferred usage of the battery cover. The preferred second step is to place the battery cover on top of a wet cell storage battery so that the edges of the battery cover extend beyond all the top edges of the battery.

FIG. 9 is a perspective view of the preferred third step in the process of preferred usage of the battery cover. The preferred third step of the process is removal of the battery cover by hand utilizing the polyethylene glove as protection.

FIG. 10 is a perspective view of the preferred fourth step in the process of preferred usage of the battery cover. The preferred fourth step of the process is insertion of the battery cover into the polyethylene storage bag and resealing the bag.

FIG. 11 is a schematic drawing illustrating the preferred manufacturing method for the preferred embodiment of the present invention.

### DETAILED DESCRIPTION OF THE INVENTION

According to a preferred embodiment of the present invention, a method and system is described with features for the prevention of corrosion of objects located close to a wet cell storage battery caused by evaporation and subsequent condensation of electrolyte vapor from a wet cell storage battery. Further, convenient methods for installation and removal are addressed by a preferred embodiment of the present invention. Additionally, convenient and safe storage methods are provided by a preferred embodiment of the current invention.

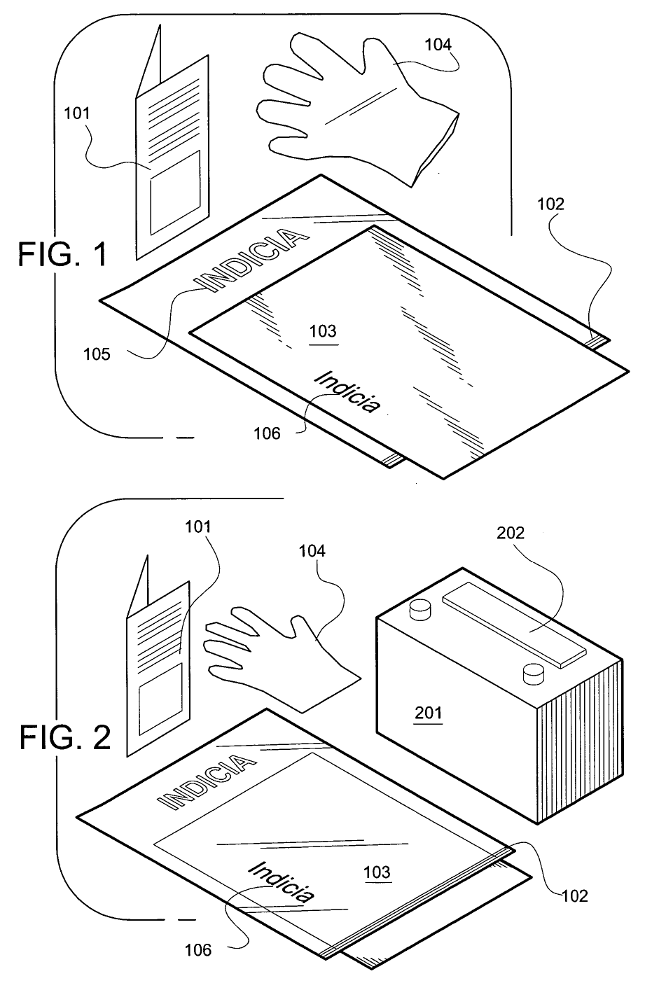

Referring to FIG. 1, the preferred components of a preferred embodiment of the present invention are shown in perspective. A preferred embodiment of the invention comprises: 1) instructions for usage and safe handling 101 (hereinafter referred to as the “instructions 101”); 2) a polyethylene storage bag with a resealable closure 102 (hereinafter referred to as the “storage bag 102”); 3) a battery cover 103; and 4) a polyethylene glove 104 (hereinafter referred to as the “glove 104”). The instructions 101 preferably use a single sheet of paper containing instructions for using the battery cover 103, safety messages and advantages of the use of the battery cover 103, applicant's company name and address, and other indicia. The storage bag 102 is preferably a polyethylene bag measuring about twelve inches wide and about fifteen inches long, with a resealable closure added along one of the about twelve-inch sides. Preferably, the polyethylene thickness is about two mils.

Preferably, the storage bag 102 is marked with bag indicia 105 to indicate which way the battery cover 103 should be inserted so that potentially condensed and un-absorbed corrosive vapor 501 is kept on one side of the storage bag 102. Preferably, the battery cover 103 is felt, preferably composed of 75% polypropylene and 25% acrylic, having a thickness of about 0.0625 inches, a width of about nine inches and a length of about fifteen inches, preferably impregnated with an acid-absorbing and neutralizing solution. Preferably, the battery cover 103 has battery cover indicia 106 imprinted on one side to assist in always placing the same side to the battery 201. As noted, the battery cover indicia 106 correspond to the bag indicia 105 to assist the user in placing the battery cover 103 in the storage bag 102 the same way each time (embodying herein re-useable closure means for re-usably closing such package means; and indicator means for indicating which corresponding side of such package means is meant to correspond to which corresponding side of such cover means).

The acid-absorbing and neutralizing solution is preferably composed of “Big Boss Cleaner/Degreaser” distributed by Franklin Maintenance Products, and water, preferably mixed in approximately equal parts prior to its absorption by the felt. Upon reading the teachings of this specification, those skilled in the art will now appreciate that, under appropriate circumstances, considering issues such as cost, ease of manufacturing, chemical properties, mechanical properties, etc., other absorbers and neutralizers, such as absorbers or neutralizers with additional properties, requiring a different proportion, non-Big Boss Cleaners, non-Big Boss Degreasers, etc., may suffice (embodying herein capture means for capturing the at least one corrosive vapor; passage means for passing the at least one volatile gas through such cover means; and neutralization means for substantially neutralizing the at least one corrosive vapor).

The glove 104 is preferably comprised of polyethylene, preferably constructed to be used on either hand, and preferably sufficiently large to be used by almost all users. Preferably, the instructions 101, the battery cover 103, and the glove 104 are placed inside the storage bag 102 to form a kit, which is sold to users in its entirety. Upon reading the teachings of this specification, those skilled in the art will now appreciate that, under appropriate circumstances, considering issues such as efficiency, ease of manufacturing, cost, etc., other kit arrangements, such as kits containing tongs instead of gloves, kits in combination with components unrelated to battery cover systems technology, kits containing non-glove removal means, etc., may suffice (embodying herein cover means for covering substantially entirely the top substantially horizontal surface of such at least one wet cell storage battery; installation means for assisting installing such at least one protection system over the at least one wet cell storage battery by at least one hand of at least one user; removal means for removing from over the at least one wet cell storage battery such protection system by the at least one hand of the at least one user; protective means for protecting the at least one hand of the at least one user; instructive means for instructing at least one user on usage of such protection system; package means for packaging such at least one protection system; and a system wherein such cover means, such protective means, and such instructive means, are placed inside such package means, and together are sold as a kit).

Referring to FIG. 2, the preferred components of a preferred embodiment of the present invention in conjunction with a typical wet cell storage battery 201 are presented in perspective. Applicant's present invention is preferably intended for use with a wet cell storage battery 201 (hereinafter referred to as the “battery 201”). A typical battery 201 utilizes lead plates and sulfuric acid to store and provide electrical energy. During charging and discharging, the chemical reaction between the lead plates and the sulfuric acid produces several byproducts, including hydrogen and a corrosive vapor comprised of water and sulfuric acid. These byproducts are vented to the atmosphere through battery vents 202. Even during periods of idleness, the battery 201 will slowly discharge, continuously producing the aforementioned byproducts.

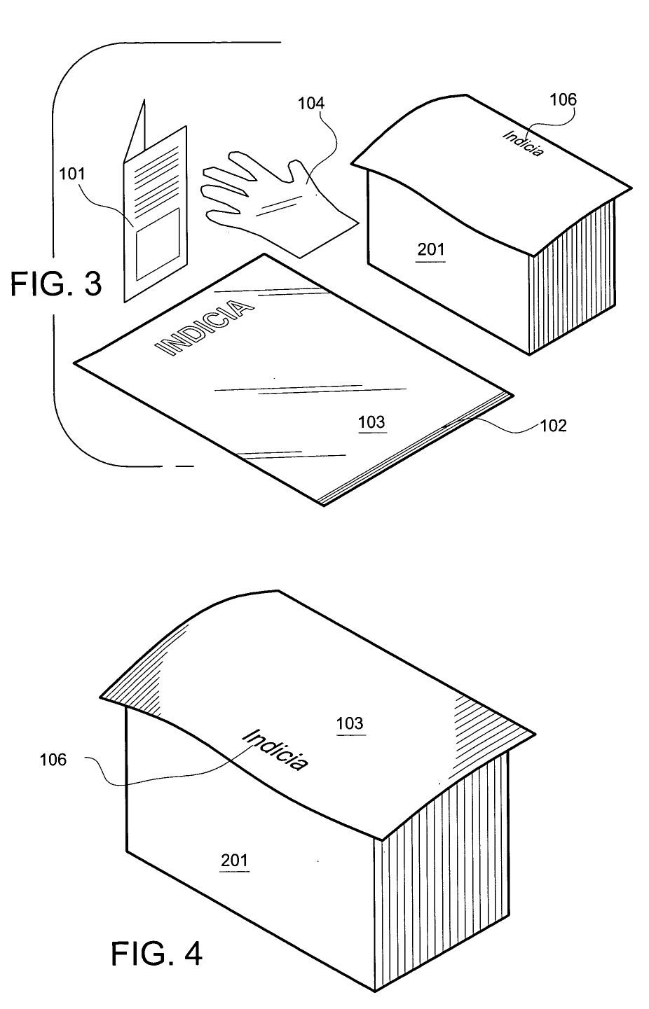

Referring to FIG. 3, the battery cover 103 placed in a preferred manner atop a battery 201 and the components of a preferred embodiment of the present invention are shown in a perspective view. Preferably, when the battery cover 103 is properly placed on a battery 201, the corrosive vapor is absorbed and neutralized by the acid-absorbing and neutralizing solution previously impregnated in the battery cover 103. However, any hydrogen 502 will pass through the battery cover 103, since it is porous to hydrogen 502. This arrangement embodies herein a system wherein such cover means further comprises a second indicator means for indicating which side of such cover means is meant to be placed touching the top substantially horizontal surface of such at least one wet cell storage battery.

Referring to FIG. 4, the battery cover 103 is shown placed in a preferred manner atop a typical battery 201 in a close-up perspective view. Preferably, proper placement of the battery cover 103 atop a battery 201 is achieved when the four edges of the Battery Blanket 103 extend beyond the four sides of the battery 201 to create the most effective barrier to the escaping corrosive vapor (as much as several inches if, for example, the location is such that breezes tend to blow the vapor quickly sideways). Preferably, the battery cover 103 is only used during periods when the equipment powered by the battery 201 is not in use.

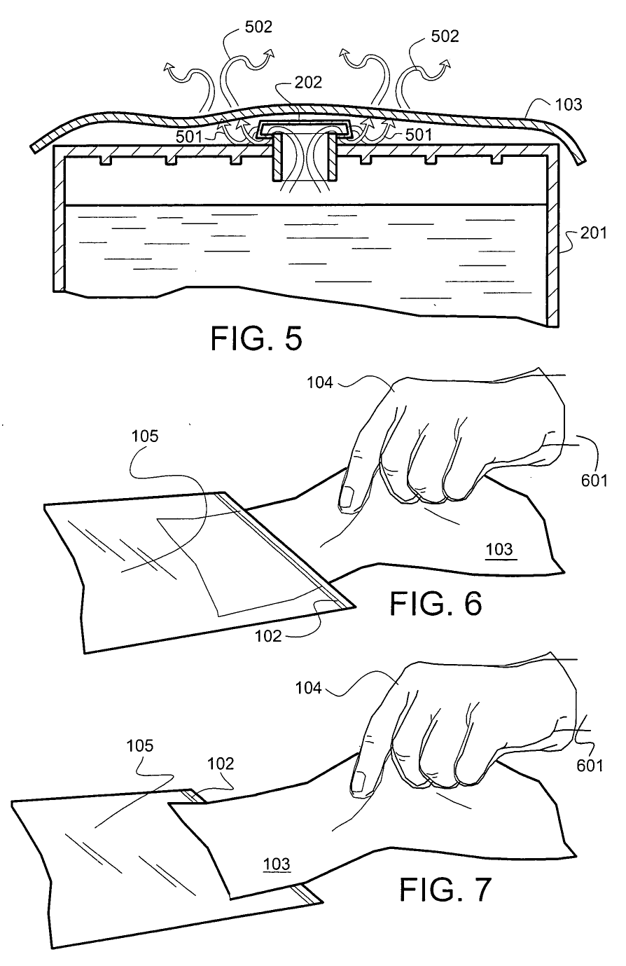

Referring to FIG. 5, it shows a cross-sectional view of the battery cover 103 placed in a preferred manner atop a wet cell storage battery 201 and depicts the emissions of corrosive vapor 501 and hydrogen gas 502 from the wet cell storage battery 201 and the intended absorption by the battery cover 103 of the corrosive vapor 501 and its permeability to hydrogen gas 502. As noted, the process of charging a battery 201 causes the electrolyte to give off hydrogen gas 502 and corrosive vapor 501, which are, in turn, vented through the battery vents 202 to prevent a build up of pressure with the battery 201. When the battery cover 103 is correctly positioned, it will preferably act as an effective barrier to corrosive vapor 501 being vented because the corrosive vapor 501 is absorbed and neutralized. Simultaneously, the hydrogen gas 502 passes through the felt because the acid-absorbing and neutralizing solution does not react to it, and the porous nature of the battery cover 103 allows it to escape to the atmosphere.

Referring to FIG. 6, a preferred first step in the process of preferred usage of the battery cover 103 is shown in a perspective view. The start of the first preferred step is to grasp the battery cover by a user's hand 601, utilizing the polyethylene glove as protection. The preferred first step of the process is completed by the removal of the battery cover 103 from the storage bag 102 by a user's hand 601, utilizing the glove 104 as protection.

Referring to FIG. 7, an illustration of the preferred method of grasping the battery cover 103 is shown in a perspective view. Preferably, the battery cover 103 is grasped from the logo or indicia side, to reduce the risk of acid burns from condensed and un-absorbed corrosive vapor 501.

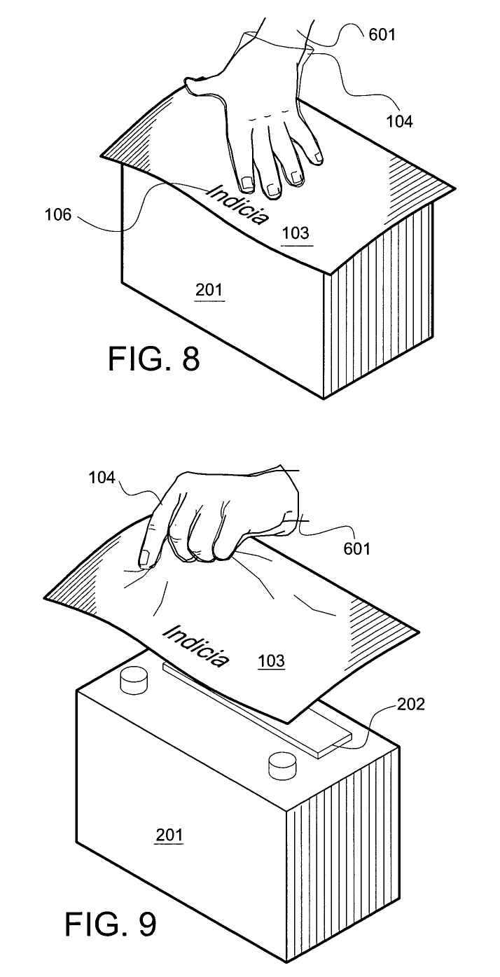

Referring to FIG. 8, a preferred second step in the preferred method of installing the battery cover 103 is shown in a perspective view. The second step in the process of preferred usage of the battery cover 103 is the preferred correct positioning of the battery cover 103 atop the battery 201 and relaxation of the grasp by user's hand 601 covered by the preferred glove 104. As noted, preferably, placement of the battery cover 103 is correct when all four edges of the battery cover 103 extend beyond the four top edges of the battery 201 (as shown in the figures). At this point, the preferred installation steps are complete, and the battery cover 103 may remain in place until removal is required.

Referring to FIG. 9, a third step in the process of preferred usage of the battery cover 103 is shown in a perspective view. The preferred third step of the process is removal of the battery cover 103 from the battery 201 by a user's hand 601, utilizing the glove 104 as protection from any risk of acid burns from condensed and un-absorbed corrosive vapor 501.

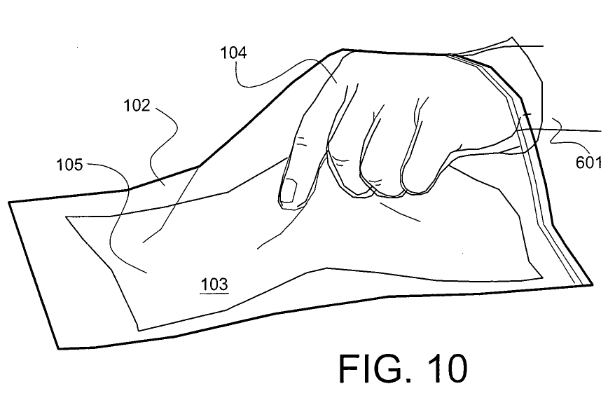

Referring to FIG. 10, a fourth step in the process of preferred usage of the battery cover 103 is shown in a perspective view. The preferred fourth step is insertion of the battery cover 103 completely inside the storage bag 102 by hand, utilizing the glove 104 as protection. Preferably, after complete insertion of the battery cover 103 into the storage bag 102, the storage bag 102 is sealed using the resealable closure. Preferably, the storage bag 102 is marked with bag indicia 106 to indicate which way the battery cover 103 should be inserted so that condensed and un-absorbed corrosive vapor 501 is kept on one side of the storage bag 102. Preferably, a user will match the bag indicia 106 with the battery cover indicia 106, which ensures that the battery cover 103 is correctly inserted each time. This arrangement embodies herein a method of minimizing escape of at least one harmful-vapor from at least one wet cell storage battery, comprising the steps of: covering at least one wet cell storage battery with a harmful-vapor neutralizing material during a period of inactivity; wherein the step of covering at least one wet cell storage battery comprises using indicia on the material to determine which side of the material is placed touching the top substantially horizontal surface of such at least one wet cell storage battery, using such indicia on the material to determine the substantially clean side of the material, using at least one glove to grasp the substantially clean side of the material, removing the material from such at least one wet cell storage battery prior to at least one period of activity; wherein the step of removing the material from such at least one wet cell storage battery comprises using indicia on the material to determine the substantially clean side of the material, using at least one glove to grasp the material on the substantially clean side of the material, inserting the material into a closeable pouch to safely store the material; wherein the step of inserting the material into a closeable pouch to safely store the material comprises using indicia on the material to determine the substantially clean side of the material, inserting the material using indicia on the material and indicia on the closeable pouch to arrange the respective sides with indicia together, and closing such closeable pouch.

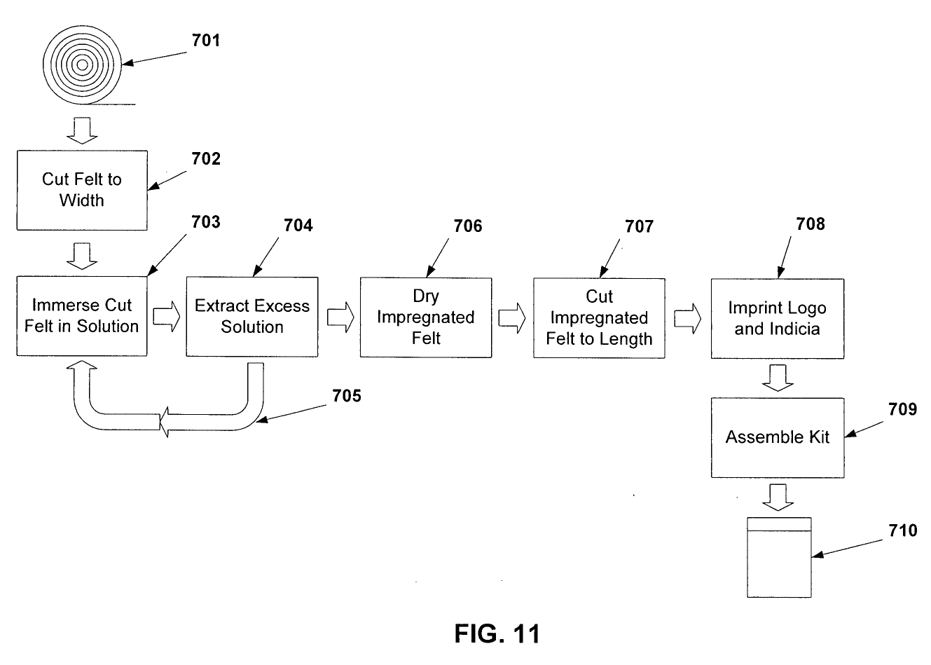

Referring now to FIG. 11, the preferred manufacturing process is shown in a summary schematic. Each of the preferred manufacturing steps is described.

The first step of the preferred manufacturing method, Cut Felt to Width 702, preferably cuts lengthwise purchased bolts of felt 701, which are approximately three feet wide and twenty-five yards long, into rolls preferably approximately nine inches wide and preferably approximately twenty-five yards long. Under appropriate circumstances, other widths and lengths may suffice. Preferably, the felt has a composition of approximately twenty-five percent acrylic and seventy-five percent polypropylene. Under appropriate circumstances, other compositions of the preferred felt may suffice.

The second step of the preferred manufacturing method, Immerse Cut Felt in Solution 703, preferably immerses the nine-inch wide felt rolls in a preferred acid-absorbing and neutralizing solution. The cut felt rolls are preferably immersed in the preferred acid-absorbing and neutralizing solution until absorption has substantially stopped. The preferred acid-absorbing and neutralizing solution is maintained at room temperature during absorption. The preferred acid-absorbing and neutralizing solution is preferably comprised of one part Big Boss Cleaner/Degreaser, commercially available from Franklin Cleaning Technology, PO Box 214, Great Bend, Kans. 57530, and one part water. The Big Boss Cleaner/Degreaser is preferred due to its alkaline pH of 12.1-12.5. Under appropriate circumstances, other alkaline products with similar characteristics may suffice.

The third step of the preferred manufacturing method, Extract Excess Solution 704, removes the unnecessary preferred acid-absorbing and neutralizing solution. The preferred method for removing excess acid-absorbing and neutralizing solution is to pass the impregnated cut felt through a wringer, which compresses the impregnated cut felt, thereby removing the excess acid-absorbing and neutralizing solution. The extracted acid-absorbing and neutralizing solution is preferably then returned 705 to the immersion bath used in the Immerse Cut Felt in Solution 703.

After removal of excess acid-absorbing and neutralizing solution, the impregnated cut felt rolls are then preferably dried in a commercial dryer for approximately thirty minutes in step four, Dry Impregnated Felt 706.

The fifth step of the manufacturing method, Cut Impregnated Felt to Length 707, preferably includes cutting the impregnated felt rolls into pieces preferably fifteen inches long. Each impregnated felt piece is preferably imprinted on one side with the preferred product name and any other preferred indicia in step six, Imprint Logo and Indicia 708. The resulting cut, impregnated, and imprinted approximately nine-inch-by-fifteen-inch felt piece is referred to elsewhere as battery cover 103.

The seventh and final manufacturing step, Assemble Kit 709, is preferably assembly of all items into a kit, which is ready for sale. Preferably, the usage instructions 101, a glove 104, and the battery cover 103 are assembled and inserted into the polyethylene storage bag 102. After insertion of the preferred items into the storage bag 102, the resealable closure on the storage bag 102 is sealed. At this point, the assembled kit is ready for shipment.

Although applicant has described applicant's preferred embodiments of this invention, it will be understood that the broadest scope of this invention includes such modifications as diverse shapes and sizes and materials. Such scope is limited only by the below claims as read in connection with the above specification. Further, many other advantages of applicant's invention will be apparent to those skilled in the art from the above descriptions and the below claims.

What is claimed is:

1) A protection system for at least one object susceptible to damage in proximity to at least one wet cell storage battery, having at least one top substantially horizontal surface, emitting at least one corrosive vapor and at least one volatile gas during at least one period of inactivity, comprising, in combination:
a) cover means for covering substantially entirely the top substantially horizontal surface of the at least one wet cell storage battery;
b) wherein said cover means comprises:
i) capture means for capturing the at least one corrosive vapor; and
ii) passage means for passing the at least one volatile gas through said cover means.

2) The protection system according to claim 1, wherein said capture means comprises:
a) neutralization means for substantially neutralizing the at least one corrosive vapor.

3) The protection system according to claim 1, further comprising:
a) installation means for assisting the installation of said at least one protection system by at least one hand of at least one user; and
b) removal means for removing, from over the at least one wet cell storage battery, said protection system utilizing the at least one hand of the at least one user.

4) The protection system according to claim 3, comprising:
a) protective means for protecting the at least one hand of the at least one user.

5) The protection system according to claim 4, further comprising:
a) instructive means for providing instructions to at least one user regarding usage of said protection system.

6) The protection system according to claim 5, further comprising:
a) package means for packaging said at least one protection system.

7) The protection system according to claim 6, wherein said package means comprises:
a) re-useable closure means for re-usably closing said package means.

8) The protection system according to claim 6, wherein said package means comprises:
a) first indicator means for indicating which corresponding side of said package means is meant to correspond to which corresponding side of said cover means.

9) The protection system according to claim 1, wherein said cover means further comprises:
a) second indicator means for indicating which side of said cover means is meant to be placed touching the top substantially horizontal surface of the at least one wet cell storage battery.

10) The protection system according to claim 9, wherein:
a) said cover means, said protective means, and said instructive means are placed inside said package means and together sold as at least one kit.

11) A protection system for at least one object susceptible to damage in proximity to at least one wet cell storage battery, having at least one top substantially horizontal surface, emitting at least one corrosive vapor and at least one volatile gas during at least one period of inactivity, comprising, in combination:
a) at least one cover structured and arranged to cover substantially entirely the top substantially horizontal surface of the at least one wet cell storage battery;
b) wherein said at least one cover comprises
i) at least one capturer structured and arranged to capture the at least one corrosive vapor, and
ii) at least one passer structured and arranged to pass the at least one volatile gas through said at least one cover.

12) The protection system according to claim 1, wherein said at least one capturer comprises:
a) at least one neutralizer structured and arranged to substantially neutralize the at least one corrosive vapor.

13) The protection system according to claim 1, further comprising:
a) at least one installer structured and arranged to assist installation of said at least one protection system by at least one hand of at least one user; and
b) at least one remover structured and arranged to remove, from over the at least one wet cell storage battery, said protection system utilizing the at least one hand of the at least one user.

14) The protection system according to claim 3, comprising:
a) at least one protector structured and arranged to protect the at least one hand of the at least one user.

15) The protection system according to claim 4, further comprising:
a) at least one instruction structured and arranged to provide instruction regarding usage of said protection system.

16) The protection system according to claim 5, further comprising:
a) at least one package structured and arranged to provide packaging of said at least one protection system.

17) The protection system according to claim 6, wherein said at least one package comprises:
a) at least one re-useable closure structured and arranged to re-usably close said at least one package.

18) The protection system according to claim 6, wherein said at least one package comprises:
a) at least one first indicator structured and arranged to indicate which corresponding side of said at least one package is meant to correspond to which corresponding side of said at least one cover.

19) The protection system according to claim 1, wherein said at least one cover further comprises:
a) at least one second indicator structured and arranged to indicate which side of said at least one cover is meant to be placed touching the top substantially horizontal surface of the at least one wet cell storage battery.

20) The protection system according to claim 9, wherein:
a) said at least one cover, said at least one protector, and said at least one instruction, are placed inside said at least one package and together sold as at least one kit.

21) A method of minimizing escape of at least one harmful vapor from at least one wet cell storage battery comprising, in combination, the steps of:
a) covering at least one wet cell storage battery with a harmful-vapor neutralizing material during a period of inactivity;
b) wherein said covering step comprises
i) using indicia on the material to determine which side of the material is placed touching the top substantially horizontal surface of such at least one wet cell storage battery,
ii) using said indicia on the material to determine the substantially clean side of the material,
iii) using at least one glove to grasp the substantially clean side of the material
c) removing the material from such at least one wet cell storage battery prior to at least one period of activity;
d) wherein said removing step comprises
i) using indicia on the material to determine the substantially clean side of the material,
ii) using at least one glove to grasp the material on the substantially clean side of the material,
e) inserting the material into a closeable pouch to safely store the material,
f) wherein said inserting step comprises
i) providing indicia on the material to determine the substantially clean side of the material,
ii) inserting the material utilizing indicia on the material and indicia on the closeable pouch to arrange the respective sides with indicia together, and
g) closing such closeable pouch.

22) A manufacturing system, which minimizes escape of at least one harmful vapor from at least one wet cell storage battery, utilizing felt rolls, an acid-absorbing solution, and a neutralizing solution, comprising, in combination, the steps of:
a) cutting felt to at least one desired width;
b) immersing the felt in the solutions;
c) extracting excess solutions from the felt;
d) drying the impregnated felt; and
e) cutting the impregnated felt to at least one desired length.

23) The system according to claim 22 further comprising the step of imprinting at least one logo and indicia on the felt.

24) The system according to claim 23 further comprising the step of assembling at least one wet cell storage battery kit.
